(19) United States
(12) Patent Application Publication
(10) Pub. No.: US 2004/0243400 A1
(43) Pub. Date: Dec. 2, 2004

(54) Speech extender and method for estimating a wideband speech signal using a narrowband speech signal

(76) Inventor: Stefano Ambrosius Klinke, Kerpen (DE)

Correspondence Address: BELL, BOYD & LLOYD, LLC, P. O. BOX 1135, CHICAGO, IL, 60690-1135, US

(21) Appl. No.: 10/491,052

(22) PCT Filed: Sep. 28, 2001
(86) PCT No.: PCT/DE01/03729

(51) Int. Cl. G10L 19/02

(52) U.S. Cl. 704/203

(57) ABSTRACT

The invention relates to a speech extender, embodied for the estimation of a broadband speech signal from a narrow/band speech signal. Furthermore, the above is adaptive such as to adjust to the coding of a communication terminal and/or to a speaker.

### BACKGROUND OF THE INVENTION

Speech coders, also referred to as speech codecs, are used for compressing the data transmission rate in speech signals. They are used principally in mobile radio systems. In GSM (Global System for Mobile Communication) mobile radio systems, speech coders are used which operate according to the method of Linear Predictive Coding (LPC). Here, in contrast to signal shape coding, it is not the speech signal itself but rather its generation process in the human speech apparatus which is simulated. Given a sampling rate of the speech signal of 8 kHz and a resolution of 13 bits, a data rate of 104 kbit/s is obtained. In the case of GSM, this data rate is reduced via LPC to a constant 13 kbit/s (referred to as code rate). For this purpose, for example in the case of GSM, full rate codec or enhanced rate codec is used. With a half rate codec, it is possible to reduce the bit rate significantly (with a correspondingly degraded speech quality) specifically to 5. 6 kbit/s.

In future communications systems such as, for example, UMTS (Universal Mobile Telecommunication System), speech coders will be used which can code speech signals with a variable bit rate. Such a speech coder is, for example, the adaptive multirate (AMR) speech coder which permits coding at various bit rates. It was designed for GSM mobile radio systems but is also to be applied as a standard speech coder in UMTS mobile radio systems.

In such speech coders, the bit rate can be adapted to the bandwidth which is available for transmitting the coded speech signal. If sufficient bandwidth is available for the transmission, the speech signal is coded with a high bit rate. This is also referred to as wideband coding. Otherwise, that is to say given a low bandwidth, coding is carried out with a low bit rate (narrowband coding).

The bit rate can be adapted during the transmission of a speech signal. For this purpose, the bandwidth of a transmission channel is continuously measured in the form of the available bit rate. If the available bit rate drops below a predefined threshold during a transmission of the speech signal, the coding is switched over so that the speech signal is coded in narrowband form.

It is possible to provide, for example, two different coding methods with correspondingly different bit rates. Wideband coding is carried out, for example, with a sampling frequency of approximately 16 kHz, while narrowband coding takes place with a sampling frequency of 8 kHz. In the first case, a speech frequency range up to 8 kHz is covered, and in the second case a speech frequency range up to 4 kHz. However, the fluctuation of the signal quality which is caused by the switching over of the bit rate, and the associated fluctuation in quality of a communications link are problematic. As a result of the predefined threshold, the switching over takes place relatively abruptly so that the quality of the link can drop suddenly during a call.

By using what is referred to as a wideband speech extender or short speech extender, it is possible to achieve a significant improvement in the speech quality, without changing a communications protocol, even when there is narrowband coding, and to reduce somewhat the quality-degrading effect of the abrupt switching over. For this purpose, the wideband speech extender uses the narrowband signal to estimate the wideband speech signal by synthesizing the speech frequency components above 4 kHz. As a result, an excessive drop in quality when switching over the bit rate for the purpose of coding is avoided. The method, made available via the wideband speech extender, for adapting the bit rate of a speech signal functions extremely well for virtually all speakers, and in particular it provides perfectly acceptable speech quality.

The present invention is intended to improve further the speech quality of a speech extender, in particular of a wideband speech extender. In addition, the present intention is to specify a method for estimating a wideband speech signal using a narrowband speech signal, permitting improved speech quality.

### SUMMARY OF THE INVENTION

The basis of the present invention is to perform adaptation to a communications terminal and/or to a speaker during the transmission of a speech signal. As a result, the speech quality can be improved further in comparison with known methods and speech extenders.

The present invention specifically relates to a speech extender which is embodied in such a way that it estimates a wideband speech signal using a narrowband speech signal. In addition, it is adaptive in such a way that it adapts to a communication terminal and/or to a speaker during coding. The adaptation preferably takes place during a speech transmission. As a result, the speech extender can continuously adapt to a remote user.

The speech extender can analyze at least one speech parameter and store and use it for adaptation. The at least one speech parameter may be a wideband speech parameter which occurs during a speech transmission. In particular, the at least one speech parameter may be speaker-specific and/or communications-terminal-specific. For example, the speech extender may be used in various mobile phones and adapt itself to their acoustic properties. In addition, it can adapt itself to various users; i.e., to their acoustic properties such as different speech frequency spectrums. Characteristic acoustic properties of the communications terminal and/or of the speaker (for example, frequency profiles, attenuation of specific frequencies or frequency ranges as well as the frequency spectrum of the voice of the speaker) are therefore preferably used as speech parameters. Such speech parameters may be determined, in particular, by measurements during a speech transmission.

The speech extender preferably performs estimations by evaluating at least one stored speech parameter. As already explained above, various speech parameters can be used for the adaptation. These are stored after being determined and are thus available at any time for the adaptation. It is also possible to update the stored parameters continuously in order to always be adapted to the current acoustic conditions in an optimum way.

Finally, the speech extender may be used in a speech coder of a mobile station and/or base station which is/are designed for a third generation mobile radio system. The third generation mobile radio system may be, in particular, UMTS.

If the mobile station is a mobile radio terminal, preferably a mobile phone, the speech extender is preferably implemented using hardware (in particular, an integrated circuit), and/or using software. Implementation using hardware provides the advantage that the speech extender can be integrated on a chip together with other essential circuit elements of the mobile radio terminal. For example, a chip manufacturer can provide such speech extenders for producers of mobile radio terminals. In contrast, implementation using software provides the advantage that the speech extender can be modified more easily, especially retrofitted, in particular if the software of the speech extender is stored in a memory which can be cleared and written to again; for example, an EEPROM.

In addition, the present invention relates to a method for estimating a wideband speech signal using a narrowband speech signal. According to the method, adaptation to a communications terminal and/or to a speaker is carried out during the estimation.

In one preferred embodiment of the method, at least one speech parameter is analyzed, stored and used for adaptation. The at least one speech parameter is preferably a wideband speech parameter which occurs during a speech transmission. In particular, the at least one speech parameter may be speaker-specific and/or communications terminal-specific.

The method advantageously may be used in a speech coder of a mobile station and/or base station which are designed for a third generation mobile radio system; in particular, UMTS. In one preferred embodiment, the mobile station is a mobile radio terminal and the method is implemented using hardware (in particular, using an integrated circuit), and/or at least partially using software.

Additional features and advantages of the present invention are described in, and will be apparent from the following Detailed Description of the Invention.

### DETAILED DESCRIPTION OF THE INVENTION

The method of operation of a wideband speech extender will firstly be explained by way of example in order to better understand the use of the present invention.

In order to generate speech frequency components above a specific frequency, a wideband excitation signal and wideband filter coefficients are required for the synthesizing filter in the speech coder. Since, as a rule, only the narrowband excitation signal and the narrowband filter coefficients are known, it is necessary to carry out a “narrowband” to “wideband” transformation. This is carried out via a wideband speech extender. The excitation signal may be extended using, for example, nonlinear signal processing. Another possibility is for white noise to be superimposed on the excitation signal.

The filter coefficients may be estimated by using two code books. The entries in the code books represent possible sets of filter coefficients. In a training phase, a narrowband code book and a wideband code book are trained. As they are trained simultaneously with the same excitation signal (once in the narrow band and once in the wide band), the relationship between the entries of both code books is known. For example, entry one of the narrowband code book corresponds to entry 2 of the wideband code book.

In the phase of use of the wideband speech extender, the two code books are used, for example, as follows:

1. The narrowband filter coefficients are calculated from the narrowband speech signal.

2. These filter coefficients are compared with the entries of the narrowband code book.

3. The most suitable entry is selected. Since the relationship between the code books is known, the optimum wideband filter coefficients are found simultaneously.

Speech signal sections are synthesized using the wideband filter coefficients which are found and the extended excitation signal.

During the extension of speech, the narrowband filter coefficients of the narrowband speech are therefore calculated. These coefficients are compared with the entries of the code book with narrowband coefficients, and the most suitable entry is selected. Since, as already explained above, the relationship between the code books is known, the optimum filter coefficients for the speech synthesis filter of the wideband speech extender are estimated.

The method also can be implemented adaptively, for example in the following steps:

1. During the wideband speech transmission, the “genuine” filter coefficients (FK) are calculated and the most suitable entry of the code book with wideband speech coefficients is searched for.

2. The code book entry is calculated again.

CB-vector(new)=c*FK+(1−c)*CB-vector(old)

3. During the narrowband speech transmission, the wideband filter coefficients are estimated using the modified code book.

An alternative is implemented in the following steps:

1. During the wideband speech transmission, the “genuine” filter coefficients (FK) are calculated.

2. The narrowband speech signal is calculated from the wideband speech signal, and the narrowband filter coefficients are determined.

3. The most suitable entry of the code book with narrowband coefficients for the narrowband filter coefficients is searched for.

4. The known relationship between the code books is used to search for the optimum entry of the code book with wideband coefficients.

5. This code book entry is calculated again.

CB-vector(new)=c*FK+(1−c)*CB-vector(old)

6. During the narrowband speech transmission, the wideband filter coefficients are estimated using the modified code book.

The speech extender according to the present invention provides a further improvement of the speech quality. It can be used particularly advantageously in all communications systems in which speech coders with a variable bit rate, which can code both in the narrow band and in the wide band (for example, in the case of GMTS), are applied.

Although the present invention has been described with reference to specific embodiments, those of skill in the art will recognize that changes may be made thereto without departing from the spirit and scope of the present invention as set forth in the hereafter appended claims.

1-10. (canceled).

11. A speech extender for estimating a wideband speech signal using a narrowband speech signal, comprising:
parts for adapting the speech extender to at least one of a communications terminal and a speaker; and
parts for analyzing and storing at least one wideband speech parameter, which occurs during speech transmission, and for using the parameter for adaptation.

12. A speech extender as claimed in claim 11, wherein the at least one speech parameter is at least one of speaker-specific and communications terminal-specific.

13. A speech extender as claimed in claim 12, wherein the speech extender carries out estimations by evaluating at least one stored speech parameter.

14. A speech extender as claimed in claim 11, wherein the speech extender is used in a speech coder of at least one of a mobile station and a base station designed for UMTS.

15. A speech extender as claimed in claim 14, wherein the mobile station is a mobile radio terminal, and the speech extender is implemented using at least one of an integrated circuit and software.

16. A method for estimating a wideband speech signal using a narrowband speech signal, the method comprising the steps of:
effecting adaptation to at least one of a communications terminal and a speaker when carrying out estimations; and
analyzing, storing and using at least one wideband speech parameter, which occurs during speech transmission, for adaptation.

17. A method for estimating a wideband speech signal using a narrowband speech signal as claimed in claim 16, wherein the at least one speech parameter is at least one of speaker-specific and communications terminal-specific.

18. A method for estimating wideband speech signal using a narrowband speech signal as claimed in claim 17, wherein estimations are effected using at least one stored speech parameter.

19. A method for estimating a wideband speech signal using a narrowband speech signal as claimed in claim 16, wherein the method is implemented in a speech coder of at least one of a mobile station and a base station designed for UMTS.

20. A method for estimating a wideband speech signal using a narrowband speech signal as claimed in claim 19, wherein the mobile station is a mobile radio terminal, and the method is effected using at least one of an integrated circuit and software.
